(19) United States
(12) Patent Application Publication
(10) Pub. No.: US 2008/0068536 A1
(43) Pub. Date: Mar. 20, 2008

(54) THIN FILM TRANSISTOR SUBSTRATE, METHOD OF MANUFACTURING THE SAME, AND LIQUID CRYSTAL DISPLAY PANEL HAVING THE SAME

(75) Inventors: Kwang Hyun KIM, Guri-si (KR); Nam Seok LEE, Suwon-si (KR); Sung-Kyu HONG, Seongnam-si (KR); Ho Yun BYUN, Hwaseong-si (KR); Sung-Hwan HONG, Suwon-si (KR); Min Jae KIM, Suwon-si (KR); Kyong Ok PARK, Bucheon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/681,943

(22) Filed: Mar. 5, 2007

(30) Foreign Application Priority Data
Sep. 18, 2006 (KR) 10-2006-0090170

(51) Int. Cl. G02F 1/1335

(52) U.S. Cl. 349/106

(57) ABSTRACT

The invention relates to a thin film transistor substrate, a method of manufacturing the thin film transistor substrate, and a liquid crystal display panel including the thin film transistor substrate. The thin film transistor substrate includes a substrate, a plurality of gate lines disposed on the substrate and extending in a first direction, a gate insulating film disposed on the gate lines, and a plurality of data lines disposed on the gate insulating film and extending in a second direction crossing the gate lines. Thin film transistors are disposed at crossings of the gate lines and the data lines and color filters are disposed on the gate insulating film. Pixel electrodes are disposed on the color filters and connected to the thin film transistors. In the thin film transistor substrate, the color filters include a red color filter, a green color filter, and a blue color filter, and the red, green, and blue color filters have different thicknesses from each other.

### CROSS REFERENCE TO RELATED APPLICATION

This application claims priority from and the benefit of Korean Patent Application No. 10-2006-0090170, filed on Sep. 18, 2006, which is hereby incorporated by reference for all purposes as if fully set forth herein.

### BACKGROUND OF THE INVENTION

1. Field of the Invention

The invention relates to a thin film transistor substrate, a method of manufacturing the same, and a liquid crystal display panel having the same. More particularly, the invention relates to a thin film transistor substrate capable of obtaining minimum black luminance in a liquid crystal display panel using a normally black mode of a twisted nematic mode by providing a step difference to a color filter on array (COA) structure on which color filters are arranged on the thin film transistor substrate, a method of manufacturing the thin film transistor substrate, and a liquid crystal display panel including the thin film transistor substrate.

2. Discussion of the Background

In general, a twisted nematic (TN) mode is divided into a normally white mode, in which the polarizing axes of upper and lower polarizing plates are orthogonal to each other and a white image appears in an inactive state (i.e. when no voltage is being applied), and a normally black mode, in which the polarizing axes of the upper and lower polarizing plates are parallel to each other and a black image appears in an inactive state.

The normally white mode is less sensitive to variations in optical characteristics due to variations in cell gaps than the normally black mode and has higher black luminance than the normally black mode. Therefore, the normally white mode is advantageous with regard to contrast ratio. However, the normally white mode also has a narrow viewing angle and allows for great variation in colors and light leakage during the manufacturing process.

Therefore, a technique for compensating for black luminance, which is a defect in the normally black mode, is needed.

### SUMMARY OF THE INVENTION

This invention provides a thin film transistor substrate capable of compensating for black luminance by providing a step difference to a color filter on array structure to form a multi-gap structure in a liquid crystal cell of a twisted nematic mode.

This invention also provides a method of manufacturing the thin film transistor substrate and a liquid crystal display panel including the thin film transistor substrate.

Additional features of the invention will be set forth in the description which follows, and in part will be apparent from the description, or may be learned by practice of the invention.

The present invention discloses a thin film transistor substrate including a substrate, a plurality of gate lines disposed on the substrate and extending in a first direction, a gate insulating film disposed on the gate lines, and a plurality of data lines disposed on the gate insulating film and extending in a second direction crossing the gate lines. Thin film transistors are disposed at crossings of the gate lines and the data lines and color filters are disposed on the gate insulating film. Pixel electrodes are disposed on the color filters and connected to the thin film transistors. The color filters include a red color filter, a green color filter, and a blue color filter, and the red color filter, the green filter, and the blue color filter have different thicknesses from each other.

The invention also discloses a liquid crystal display panel including a thin film transistor substrate, a common electrode substrate, and liquid crystals injected between the thin film transistor substrate and the common electrode substrate. The thin film transistor substrate includes a first substrate, a plurality of gate lines disposed on the first substrate and extending in a first direction, a gate insulating film disposed on the gate lines, and a plurality of data lines disposed on the gate insulating film and extending in a second direction crossing the gate lines. Thin film transistors are disposed at crossings of the gate lines and the data lines and color filters are disposed on the gate insulating film. Pixel electrodes are disposed on the color filters and connected to the thin film transistors. The common electrode substrate is arranged opposite the thin film transistor substrate and includes a second substrate and a common electrode formed on the second substrate. Liquid crystals are between the thin film transistor substrate and the common electrode substrate. In the liquid crystal display panel, cell gaps between the thin film transistor substrate and the common electrode substrate are different in different regions of the display panel.

The present invention also provides a method of manufacturing a thin film transistor substrate including forming gate lines extending in a first direction and including gate electrodes on a substrate, sequentially forming an insulating film, an active layer, and an ohmic contact layer on the gate lines to form active regions of thin film transistors, forming data lines extending in a second direction crossing the gate lines and including source electrodes on the substrate, and forming color filters on the substrate. The color filters include a red color filter, a green color filter, and a blue color filter and the red color filter, the green color filter, and blue color filter have different thicknesses from each other. The method further includes forming contact holes in the color filters that expose parts of the drain electrodes and forming pixel electrodes on the color filters, the pixel electrodes being connected to the drain electrodes through the contact holes.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view schematically showing a thin film transistor substrate of a liquid crystal display panel according to an exemplary embodiment of the invention.

FIG. 2A is a cross-sectional view of the liquid crystal display panel taken along line I-I of FIG. 1.

FIG. 2B is a cross-sectional view of the liquid crystal display panel taken along line II-II of FIG. 1.

FIG. 3 is a cross-sectional view of a liquid crystal display panel taken along line II-II of FIG. 1 according to another exemplary embodiment of the invention.

FIG. 4A is a graph showing a minimum transmission curve calculated by means of the Gooch-Tarry formula.

FIG. 4B is a graph showing the minimum transmission curves for red, green, and blue wavelengths.

FIG. 5 is a graph showing the minimum transmission curves for red, green, and blue wavelengths when the cell gaps are adjusted such that these wavelengths have minimum transmittances at a first minimum transmission point.

FIG. 6 is a graph showing the minimum transmission curves for red, green, and blue wavelengths when the cell gaps are adjusted such that these wavelengths have minimum transmittances at a second minimum transmission point.

FIG. 7 is a conceptual diagram showing a process of preventing light leakage from a liquid crystal display panel according to an exemplary embodiment of the invention.

FIG. 8A, FIG. 8B, FIG. 8C, FIG. 8D, FIG. 8E, FIG. 8F, FIG. 8G, and FIG. 8H are cross-sectional views showing a process of manufacturing a thin film transistor substrate according to an exemplary embodiment of the invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element or layer is referred to as being “directly on” or “directly connected to” another element or layer, there are no intervening elements or layers present.

Hereinafter, exemplary embodiments of the invention will be described in detail with reference to the accompanying drawings.

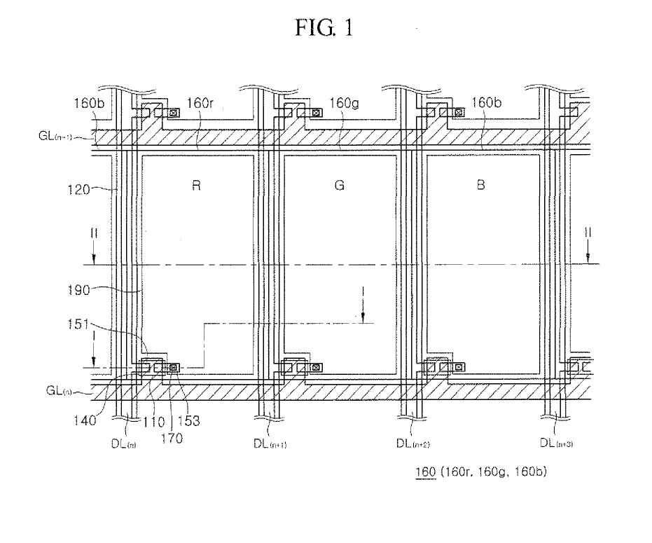

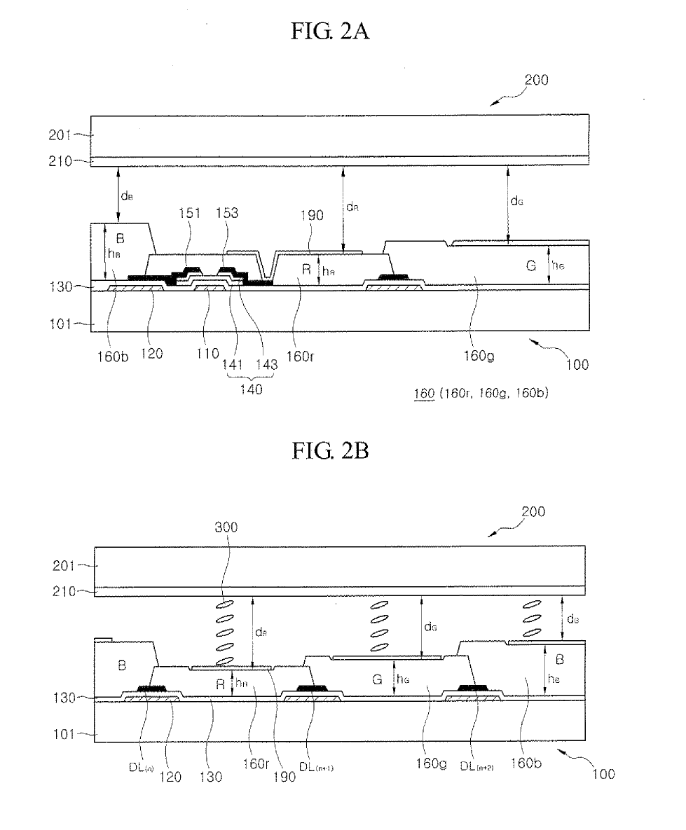

FIG. 1 is a plan view showing a thin film transistor substrate of a liquid crystal display panel according to an exemplary embodiment of the invention. FIG. 2A is a cross-sectional view of the liquid crystal display panel taken along line I-I of FIG. 1, and FIG. 2B is a cross-sectional view of the liquid crystal display panel taken along line II-II of FIG. 1.

Referring to FIG. 1, FIG. 2A, and FIG. 2B, the liquid crystal display panel includes a thin film transistor substrate 100, a common electrode substrate 200, including a substrate 201 and a common electrode 210, arranged opposite the thin film transistor substrate 100, and liquid crystals 300 injected between the substrates.

The thin film transistor substrate 100 includes a transparent insulating substrate 101, gate lines GL extending in a first direction disposed on the substrate 101 and including gate electrodes 110, and a black matrix 120 disposed on the substrate 101 and extending in a second direction crossing the gate lines GL, that is, in a direction parallel to data lines, which will be described later. A gate insulating film 130 is disposed on the gate lines GL and the black matrix 120 and data lines DL are disposed on the gate insulating film 130. The data lines DL extend in the second direction crossing the gate lines GL and include source electrodes 151. Thin film transistors, which are disposed at crossings of the gate lines GL and the data lines DL, are connected to the gate lines GL and the data lines DL and each include a gate electrode 110, a source electrode 151, and a drain electrode 153. Color filters 160 are disposed on the gate insulating film 130 and contact holes 170 are formed in the color filters 160 such that a portion of the drain electrode 153 is exposed. Pixel electrodes 190 are disposed on the color filters 160 and connected to the drain electrodes 153 of the thin film transistors through the contact holes 170.

In this case, the color filters 160 include a red color filter 160r, a green color filter 160g, and a blue color filter 160b. The red, green, and blue color filters have different thicknesses. That is, the red color filter 160r has the smallest thickness h_{R}, the blue color filter 160b has the largest thickness h_{B}, and the green color filter 160g has a thickness hg between h_{R} and h_{B}. The thicknesses of the color filters may vary according to the Gooch-Tarry formula.

As described above, the color filters are formed to have different thicknesses, which causes the cell gaps between the thin film transistor substrate 100 and the common electrode substrate 200 in the vicinity of each color filter to be different. This results in a multi-gap structure between the two substrates. That is, the cell gap d_{R} of the red color filter 160r is the largest, followed by the cell gap d_{G} of the green color filter 160g and the cell gap d_{B} of the blue color filter 160b.

The gate lines GL are disposed on the substrate 101 and extend in the horizontal direction. A gate pad (not shown) is disposed at one end of each gate line GL. The black matrix 120 is arranged in a direction crossing the gate lines GL on the same surface as the gate lines GL. In this case, it is preferable that the black matrix 120 be wider than the data line DL, but it may be narrower or have the same width.

The gate insulating film 130 is disposed on the gate lines GL and the black matrix 120. Then, an active layer 141 and an ohmic contact layer 143 are disposed on the gate insulating film 130 and patterned to form an active region.

The data lines DL are disposed in the vertical direction on the gate insulating film 130 and a data pad (not shown) is disposed at one end of each data line DL. As described above, the thin film transistor includes the gate electrode 110 connected to the gate line GL, the source electrode 151 connected to the data line DL, the drain electrode 153 connected to the pixel electrode 190, the gate insulating layer 130 and the active layer 141 that are sequentially disposed between the gate electrode 110 and the source and drain electrodes 151 and 153, and the ohmic contact layer 143 that is disposed on at least a portion of the active layer 141. The ohmic layer 143 may be formed on a portion of the active layer 141 other than a channel portion.

The color filters 160, including the red color filter 160r, the green color filter 160g, and the blue color filter 160b, are disposed on the gate insulating film 130 having the thin film transistors and the data lines DL formed thereon. The thicknesses of the red color filter 160r, green color filter 160g, and blue color filter 160b are different from each other. A contact hole 170 is formed in each color filter 160 to expose a portion of the drain electrode 153. The pixel electrodes 190 are disposed on the color filters 160 and connected to the drain electrodes 153 of the thin film transistors through the contact holes 170. In this case, the pixel electrodes 190 may be made of a transparent conductive material, such as indium tin oxide (ITO) or indium zinc oxide (IZO).

In general, light having various wavelengths, rather than a single wavelength like white light, which is an overlap of a red wavelength, a green wavelength, and a blue wavelength, is incident on the liquid crystals. That is, light components having different wavelengths are incident on the liquid crystals. The point where minimum black luminance is obtained is determined by the minimum transmission curve calculated by means of the Gooch-Tarry formula, which will be described below. In this case, since a red light component, a green light component, and a blue light component have different wavelengths, the points where the minimum black luminance is obtained for each wavelength do not match to form a uniform gap structure. This causes a blackish color, rather than full black, to appear on the display. Therefore, as described above, when the red color filter, the green color filter, and the blue color filter have different thicknesses and form a multi-gap structure between the thin film transistor substrate and the common electrode substrate, the points where the minimum black luminance is obtained for each light wavelength may be matched with each other, making it possible to improve the black luminance.

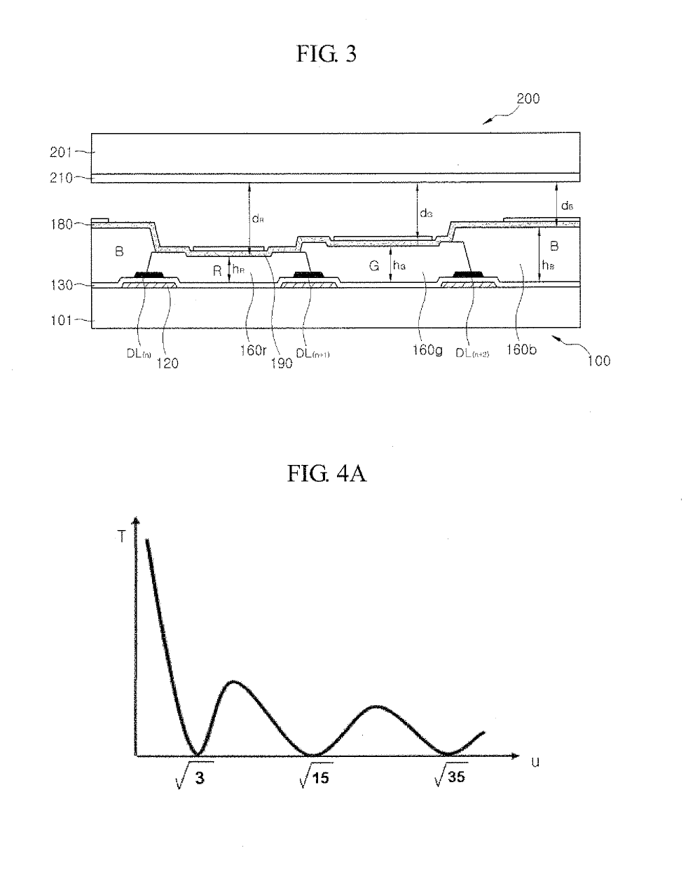

FIG. 3 is a cross-sectional view of a liquid crystal display panel taken along line TI-II of FIG. 1 according to another exemplary embodiment of the invention. The liquid crystal display panel shown in FIG. 3 is similar to the liquid crystal display panel shown in FIG. 2A and FIG. 2B except that a capping layer is disposed between the color filters and the pixel electrodes. Therefore, differences between the liquid crystal display panel shown in FIG. 3 and the liquid crystal display panel shown in FIG. 2A and FIG. 2B will be described below.

Referring to FIG. 3, a thin film transistor substrate 100 includes a transparent insulating substrate 101, gate lines GL extending in a first direction disposed on the substrate 101 and including gate electrodes 110, and a black matrix 120 disposed on the substrate 101 and extending in a second direction crossing the gate lines GL, that is, in a direction parallel to data lines, which will be described later. A gate insulating film 130 is disposed on the gate lines GL and the black matrix 120 and data lines DL are disposed on the gate insulating film 130. The data lines DL extend in the second direction crossing the gate lines GL and include source electrodes 151. Thin film transistors, which are disposed at crossings of the gate lines GL and the data lines DL, are connected to the gate lines GL and the data lines DL and each include a gate electrode 110, a source electrode 151, and a drain electrode 153. Color filters 160 are disposed on the gate insulating film 130 having the thin film transistors and the data lines DL formed thereon. A capping layer 180 is disposed on the color filters 160 and contact holes 170 are formed in the color filters 160 and the capping layer 180 to expose a portion of the drain electrode 153. Pixel electrodes 190 are disposed on the capping layer 180 and are connected to the drain electrodes 153 of the thin film transistors through the contact holes 170. In this case, the color filters include a red color filter 160r, a green color filter 160g, and a blue color filter 160b, and the red color filter 160r, the green color filter 160g, and the blue color filter 160b are formed with different thicknesses.

The capping layer 180 may be made of the same material as the gate insulating film 130, which, for example, may be made of a silicon nitride. The capping layer 180 prevents the material forming the color filter 160 from flowing into the liquid crystals 300 and thus, prevents the occurrence of an after image on the display.

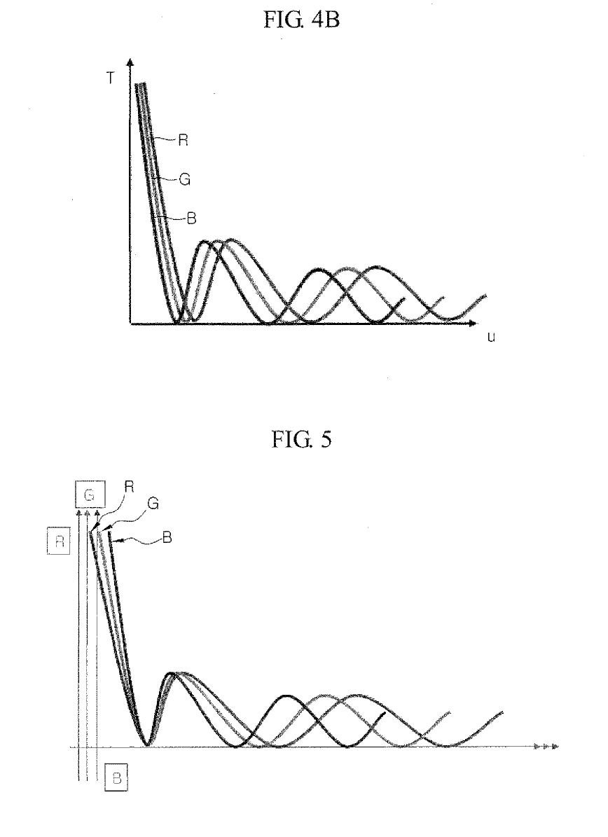

FIG. 4A is a graph showing a minimum transmission curve calculated by means of the Gooch-Tarry formula and FIG. 4B is a graph showing a minimum transmission curve for each wavelength.

The minimum transmission curve shown in FIG. 4A is a graph representing the transmittance calculated by varying a ‘u’ value in the following Gooch-Tarry formula:

$$T = \frac{{sin}^{2} ( \frac{π}{2} \sqrt{1 + {u}^{2}} )}{( 1 + {u}^{2} )} . \qquad [ Expression 1 ]$$

Gooch and Tarry obtained the above-mentioned result with respect to light transmittance in an inactive state in a normally black mode of a twisted nematic mode. In Expression 1, T is the transmittance with respect to unpolarized monochromatic light, and u is as follows:

$$u = \frac{2 Δ nd}{λ} , \qquad [ Expression 2 ]$$

where Δn is the birefringence of the liquid crystals, ‘d’ is a cell gap, and λ is a wavelength.

As the value of u increases, the liquid crystals get closer to a linearly polarized state, which causes a reduction in transmittance. Therefore, when u=\sqrt{3}, a first minimum transmission point is obtained. When u=\sqrt{15} and u=\sqrt{35}, second and third minimum transmission points are obtained. In this way, an n-th minimum transmission point may be obtained.

For example, assuming that Δn is in the range of 0.09 to 0.1 and λ is 550 nm at the first minimum transmission point, that is, when u=\sqrt{3}, the minimum transmittance is obtained at a cell gap ‘d’ of about 5 μm. Therefore, when the Gooch-Tarry formula is used, it is possible to calculate the efficiency of the minimum transmittance, that is, determine the cell gap capable of increasing the black luminance to the maximum in the inactive state of the normally black mode of the twisted nematic mode.

FIG. 4B shows a graph representing a minimum transmission curve for each wavelength. Referring to FIG. 4B, in general, light having various wavelengths, not a single wavelength like white light, is incident on the liquid crystals. That is, light components having different wavelengths are incident on the liquid crystals. For example, the wavelength of the red light component is 610 nm, the wavelength of the green light component is 555 nm, and the wavelength of the blue light component is 435 nm. Therefore, as shown in FIG. 4A, when the birefringence of the liquid crystals is in the range of 0.09 to 0.1 and the cell gap has a constant value of about 5 μm, the first minimum transmission points of the red, green, and blue light components, that is, the values of ‘u’, are different from each other. The green light component has the first minimum transmission point with the value of u=\sqrt{3}, but the red light component and the blue light component have first minimum transmission points at values other than \sqrt{3} since the wavelengths thereof are different from the wavelength of the green light component. Therefore, in a uniform gap structure, in which the cell gaps of the liquid crystal display panel are uniform, the minimum transmittances of light components are obtained at different points, which causes a blackish color, rather than full black, to appear on the display. Thus, as in the invention, in order to make points where the minimum transmittance of light components are substantially identical to each other, color filters of the liquid crystal display panel are formed at different cell gaps in predetermined regions, that is, wavelength regions.

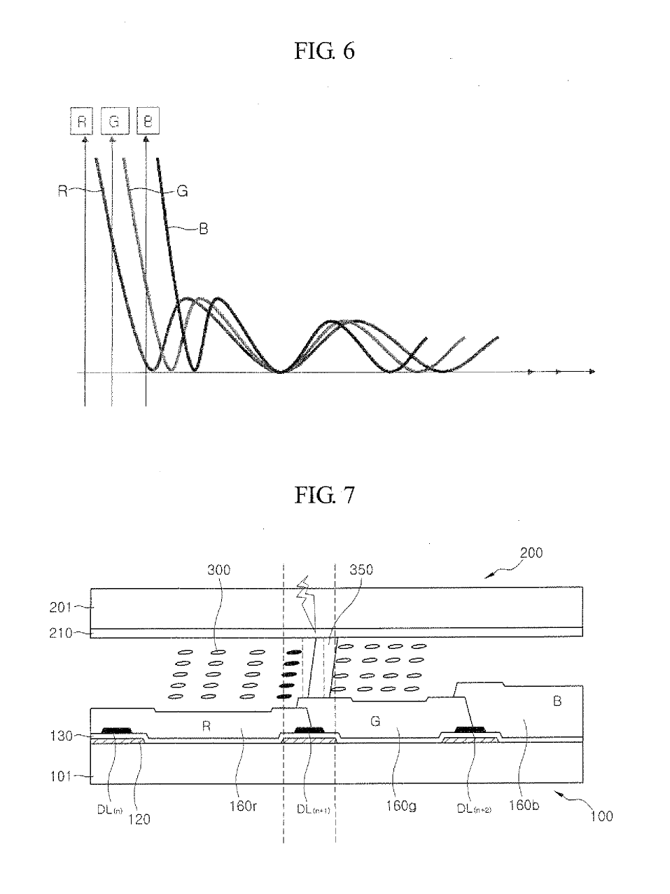

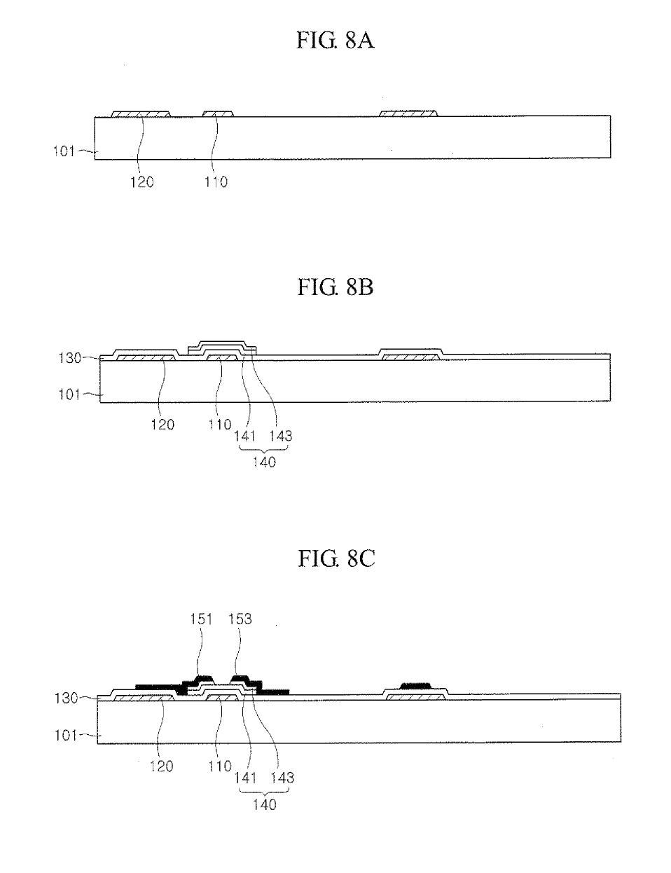

FIG. 5 is a graph showing the minimum transmission curves for red, green, and blue light components when the cell gaps are adjusted such that the first minimum transmission points of these light components are substantially identical to each other, and FIG. 6 is a graph showing the minimum transmission curves for the red, green, and blue light components when the cell gaps are adjusted such that the second minimum transmission points of these light components are substantially identical to each other.

FIG. 5 is a graph showing the minimum transmission curves for the red, green, and blue light components when the cell gaps are adjusted such that these light components have minimum transmittances at the first minimum transmission point, that is, the value of u=\sqrt{3}. Assuming that the birefringence of the liquid crystals is 0.1, the cell gap d_{G} of a region emitting a green light component (for example, a light component having a wavelength of 555 nm), that is, a green color filter region, is about 4.8 μm, the cell gap d_{R} of a region emitting a red light component (for example, a light component having a wavelength of 610 nm), that is, a red color filter region, is about 5.3 μm, and the cell gap d_{B} of a region emitting a blue light component (for example, a light component having a wavelength of 435 nm), that is, a blue color filter region, is about 3.8 μm (see FIG. 2A and FIG. 2B). The above-mentioned cell gaps are just illustrative examples and the invention is not limited thereto. For example, the cell gaps may vary according to the birefringence of the liquid crystals and the wavelength of light.

FIG. 6 is a graph showing the minimum transmission curves for the red, green, and blue light components when the cell gaps are adjusted such that these light components have minimum transmittances at the second minimum transmission point, that is, the value of u=\sqrt{15}, rather than at the first transmission point. Assuming that liquid crystals having high birefringence (for example, in the range of 0.15 to 0.25) are used, the cell gap d_{G} of the region emitting the green light component (for example, the light component having a wavelength of 555 nm), that is, the green color filter region, is in the range of about 7 to 10 μm, the cell gap d_{R} of the red color filter region is larger than the cell gap d_{G}, and the cell gap d_{B} of the blue color filter region is smaller than the cell gap d_{G}.

As described above, when the liquid crystals having high birefringence are used to adjust the cell gaps such that the second minimum transmission points of the light components are identical to each other, it may be possible to prevent black luminance from varying due to a variation in the cell gap, and thus, may be possible to ensure a sufficient process margin.

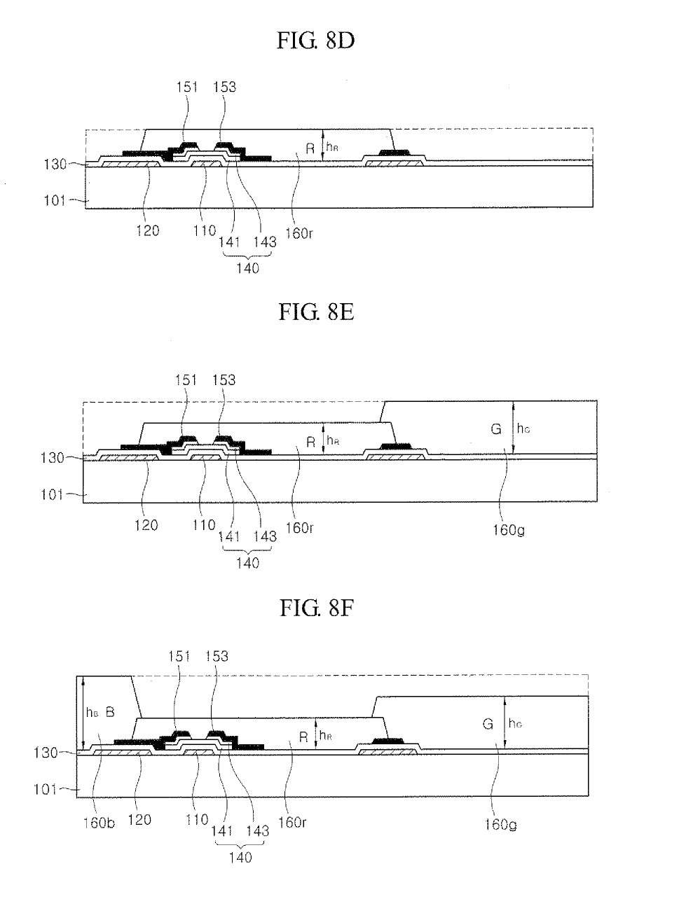

FIG. 7 is a conceptual diagram showing a process of preventing light leakage from a liquid crystal display panel according to an exemplary embodiment of the invention.

Referring to FIG. 7, column spacers 350 are arranged between the thin film transistor substrate 100 and the common electrode substrate 200 and maintain a uniform cell gap therebetween. In this case, the column spacers 350 are arranged above the black matrix 120 disposed on the thin film transistor substrate 100.

Even when the color spacers 350 deviate from the original positions because of an external shock, all of the liquid crystal molecules may be kept in a black state in the normally black mode of the twisted nematic mode, which, unlike the normally white mode, prevents light leakage.

Further, the black matrix 120 disposed on the thin film transistor substrate 100 may make it possible to reduce the number of process steps required to form the common electrode substrate 200 and also may prevent light leakage due to the misalignment of the black matrix when the substrates are bonded to each other.

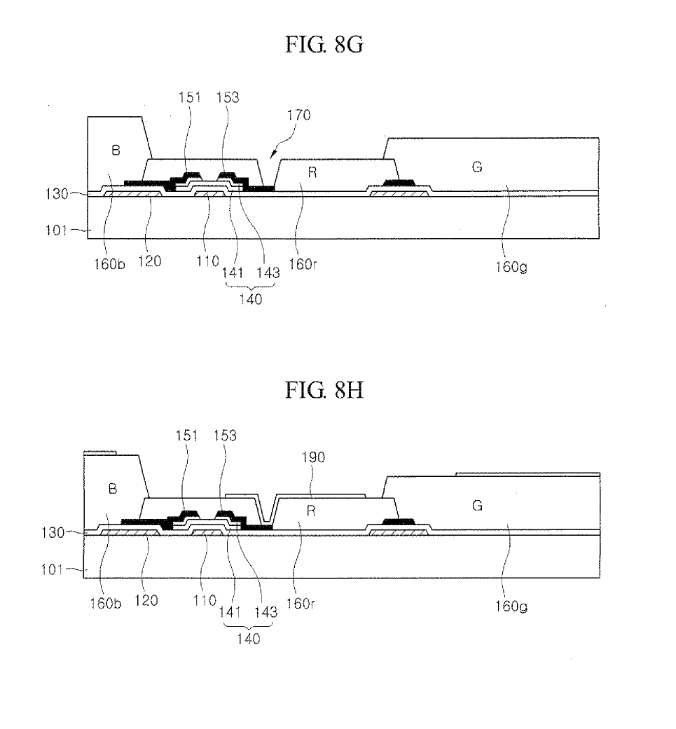

FIG. 8A, FIG. 8B, FIG. 8C, FIG. 8D, FIG. 8E, FIG. 8F, FIG. 8G, and FIG. 8H are cross-sectional views showing a process of manufacturing a thin film transistor substrate according to an exemplary embodiment of the invention.

Referring to FIG. 8A, a first conductive film may be disposed on the transparent insulating substrate 101 by a vapor deposition method, such as a chemical vapor deposition (CVD) method, a plasma vapor deposition (PVD) method, or a sputtering method. In this case, the first conductive film may be made of at least one of Cr, MoW, Cr/Al, Cu, Al(Nd), Mo/Al, Mo/Al(Nd), and Cr/Al(Nd). In addition, the first conductive film may be a multi-layer film. A photosensitive film is disposed on the first conductive film, and a photolithography process, using a first mask (not shown), is performed to form a first photosensitive film mask pattern (not shown). Subsequently, an etching process is performed, using the first photosensitive film mask pattern as an etching mask, to form the gate lines GL, including the gate electrodes 110, and the black matrix 120, as shown in FIG. 8A. Then, a stripping process is performed to remove the first photosensitive film mask pattern.

Referring to FIG. 8B, the gate insulating film 130, the active layer 141, and the ohmic contact layer 143 are sequentially disposed on the substrate shown in FIG. 8A, and an etching process is performed, using a second photosensitive film mask pattern (not shown), to form active regions of the thin film transistors.

The gate insulating film 130 may be disposed on the substrate by a vapor deposition method, such as a PECVD method or a sputtering method. In this case, the gate insulating film 130 may be made of an inorganic insulating material, such as a silicon oxide or a silicon nitride. The active layer 141 and the ohmic contact layer 143 may be sequentially disposed on the gate insulating film 130 by a vapor deposition method. An amorphous silicon layer may be used as the active layer 141 and an amorphous silicon layer having silicide or n-type impurities heavily doped therein may be used as the ohmic contact layer 143. Then, a photosensitive film is disposed on the ohmic contact layer 143, and a photolithography process, using a second mask (not shown), is performed to form a second photosensitive film mask pattern (not shown). Subsequently, an etching process is performed, using the second photosensitive film mask pattern as an etching mask and the gate insulating film 130 as an etch stop layer, to remove the ohmic contact layer 143 and the active layer 141, thereby forming an active region 140 having a predetermined shape above the gate electrode 110. Then, a stripping process is performed to remove the remaining second photosensitive film mask pattern.

Referring to FIG. 8C, a second conductive film is disposed on the entire surface of the substrate having the active regions of the thin film transistors disposed thereon, and an etching process, using a third photosensitive film mask pattern (not shown), is performed to form the data line DL, the source electrode 151, and the drain electrode 153.

The second conductive film may be disposed on the substrate by a vapor deposition method, such as a CVD method, a PVD method, or a sputtering method. In this case, the second conductive film may be composed of either a single metal layer including Mo, Al, Cr, or Ti or a multi-layer film including the metallic materials. Of course, the second conductive film may be made of the same material as the first conductive film. A photosensitive film is disposed on the second conductive film, and a photolithography process, using a mask, is performed to form the third photosensitive film mask pattern. Then, an etching process is performed on the second conductive film, using the third photosensitive film mask pattern as an etching mask, and the third photosensitive film mask pattern is removed. Subsequently, etching is performed, using the etched second conductive film as an etching mask, to remove the ohmic contact layer 143 exposed through the second conductive film, thereby forming a channel composed of the active layer 141 between the source electrode 151 and the drain electrode 153.

Referring to FIG. 8D, FIG. 8E, FIG. 8F, and FIG. 8G, the color filters 160, including the red color filter 160r, the green color filter 160g, and the blue color filter 160b, are formed on the entire surface of the substrate having the thin film transistors and the data lines DL disposed thereon. In this case, the red, green, and blue color filters are formed so as to have different thicknesses. That is, the red, green, and blue color filters are formed such that the thickness h_{R} of the red color filter is less than the thickness hg of the green color filter, which is less than the thickness h_{B} of the blue color filter. Then, an etching process, using a fourth photosensitive film mask pattern, is performed to remove a portion of the color filters 160, thereby forming the contact holes 170.

Referring to FIG. 8H, a third conductive film is disposed on the color filters 160, and the third conductive film is patterned, using a fifth photosensitive film mask pattern (not shown), to form the pixel electrode 190. In this case, it is preferable that the third conductive film be made of a transparent conductive material such as ITO or IZO.

As described above, according to an exemplary embodiment of the invention, a step difference is provided to a color filter on array structure to form a multi-gap structure in liquid crystal cells of a twisted nematic mode, which may make it possible to compensate for black luminance, which is a defect in the normally black mode. As a result, it may be possible to ensure a larger viewing angle in the normally black mode than in the normally white mode and also, to prevent light leakage.

Further, the black matrix is disposed on the thin film transistor substrate, which may make it possible to reduce the number of process steps required to form a common electrode substrate and also may prevent light leakage due to the misalignment of the black matrix when the two substrates are bonded to each other.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A thin film transistor substrate, comprising:
a substrate;
a plurality of gate lines disposed on the substrate and extending in a first direction;
a gate insulating film disposed on the gate lines;
a plurality of data lines disposed on the gate insulating film and extending in a second direction crossing the gate lines;
thin film transistors disposed at crossings of the gate lines and the data lines;
color filters disposed on the gate insulating film; and
pixel electrodes disposed on the color filters and connected to the thin film transistors,
wherein the color filters comprise a red color filter, a green color filter, and a blue color filter, and the red color filter, the green color filter, and the blue color filter comprise different thicknesses from each other.

2. The thin film transistor substrate of claim 1, wherein the thin film transistors each comprise:
a gate electrode,
an active layer,
an ohmic contact layer,
a source electrode, and
a drain electrode.

3. The thin film transistor substrate of claim 1,
wherein the blue color filter has the largest thickness and the red color filter has the smallest thickness.

4. The thin film transistor substrate of claim 1, further comprising:
a capping layer disposed between the color filters and the pixel electrode.

5. The thin film transistor substrate of claim 1, further comprising:
a black matrix disposed on the substrate and extending in the second direction.

6. The thin film transistor substrate of claim 5, wherein the width of the black matrix is greater than the width of the data lines.

7. A liquid crystal display panel, comprising:
a thin film transistor substrate comprising:
a first substrate,
a plurality of gate lines disposed on the first substrate and extending in a first direction,
a gate insulating film disposed on the gate lines,
a plurality of data lines disposed on the gate insulating film and extending in a second direction crossing the gate lines,
thin film transistors disposed at crossings of the gate lines and the data lines,
color filters disposed on the gate insulating film, and
pixel electrodes disposed on the color filters and connected to the thin film transistors;
a common electrode substrate arranged opposite the thin film transistor substrate and comprising:
a second substrate, and
a common electrode disposed on the second substrate; and
liquid crystals between the thin film transistor substrate and the common electrode substrate,
wherein cell gaps between the thin film transistor substrate and the common electrode substrate are different from each other in different regions of the display panel.

8. The liquid crystal display panel of claim 7,
wherein the color filters comprise a red color filter, a green color filter, and a blue color filter, and
the red color filter, the green color filter, and the blue color filter comprise different thicknesses from each other.

9. The liquid crystal display panel of claim 8, wherein the blue color filter has the largest thickness and the red color filter has the smallest thickness.

10. The liquid crystal display panel of claim 7, further comprising:
a capping layer disposed between the color filters and the pixel electrode.

11. The liquid crystal display panel of claim 7, further comprising:
a black matrix disposed on the first substrate and extending in the second direction.

12. The liquid crystal display panel of claim 11, wherein the width of the black matrix is greater than the width of the data lines.

13. The liquid crystal display panel of claim 7, wherein the liquid crystals are in a twisted nematic mode.

14. The liquid crystal display panel of claim 13, wherein the liquid crystal display panel is in a normally black mode.

15. A method for manufacturing a thin film transistor substrate, comprising;
forming gate lines extending in a first direction and comprising gate electrodes on a substrate;
sequentially forming a gate insulating film, an active layer, and an ohmic contact layer on the gate lines to form active regions of thin film transistors;
forming data lines extending in a second direction crossing the gate lines and comprising source electrodes;
forming color filters comprising a red color filter, a green color filter, and a blue color filter, the red color filter, the green color filter, and the blue color filter comprising different thicknesses from each other; forming contact holes in the color filters such that parts of drain electrodes are exposed; and
forming pixel electrodes on the color filters so as to be connected to the drain electrodes through the contact holes.

16. The method of claim 15,
wherein forming the color filters comprises:
forming the blue color filter to have the largest thickness, and
forming the red color filter to have the smallest thickness.

17. The method of claim 15, further comprising:
forming a capping layer on the color filters,
wherein forming the contact holes comprises:
forming the contact holes in the capping layer and the color filters.

18. The method of claim 15 further comprising:
:forming a black matrix extending in the second direction on the substrate.
